(19) United States
(12) Patent Application Publication
(10) Pub. No.: US 2026/0172554 A1
(43) Pub. Date: Jun. 18, 2026

(54) NEURAL NETWORK (NN) IN-LOOP FLEXIBILITY SYNTAX FOR PATCH INFORMATION

(71) Applicant: Telefonaktiebolaget LM Ericsson (publ), Stockholm (SE)

(72) Inventors: Martin PETTERSSON, Stockholm (SE); Mitra DAMGHANIAN, Stockholm (SE); Rickard SJÖBERG, Stockholm (SE)

(73) Assignee: Telefonaktiebolaget LM Ericsson (publ), Stockholm (SE)

(21) Appl. No.: 19/361,405

(22) Filed: Oct. 17, 2025

Related U.S. Application Data
(60) Provisional application No. 63/734,255, filed on Dec. 16, 2024.

(51) Int. Cl. H04N 19/117; H04N 19/167; H04N 19/172; H04N 19/176; H04N 19/177; H04N 19/70; H04N 19/82

(52) U.S. Cl. CPC H04N 19/117; H04N 19/167; H04N 19/172; H04N 19/70; H04N 19/82; H04N 19/176; H04N 19/177

(57) ABSTRACT

A method for decoding one or more pictures from a bitstream, the one or more pictures comprising a first picture. The method includes obtaining patch information for the first picture. The method also includes generating a first input patch using the patch information for the first picture. The method also includes applying a neural network (NN) filter to the first input patch, thereby generating a first output patch, The method also includes decoding the first picture and/or one or more other pictures of the one or more pictures using the first output patch.

### CROSS-REFERENCE TO RELATED APPLICATIONS

This application claims the benefit of U.S. provisional patent application No. 63/734,255, filed on 2024 Dec. 16, which is incorporated by this reference.

### TECHNICAL FIELD

Disclosed are embodiments related to video coding and, more specifically, neural network (NN) based loop filtering.

### BACKGROUND

### 1. Video Compression

Video is a dominant form of data traffic in today's networks and is projected to increase its share. One way to reduce the data traffic in a network caused by the transmission of video data is to compress the video data before transmission. For example, the video data (a.k.a., source video) can be encoded to a coded video bitstream (or just “bitstream” for short), which then can be stored and transmitted to end users. A decoder can produce video from the encoded data in the bitstream and display the produced video (also known as the decoded video) on a screen. If a lossless video compression is used, the decoded video should be identical to the source video.

Because the encoder may not know what kind of device the bitstream is going to be sent to, it is advantageous for the encoder to compress the video according to a video encoding standard, such as the Versatile Video Coding (VVC) standard, the High Efficiency Video Coding (HEVC) standard, and the AOMedia Video 1 (AV1) video coding format, to name a few. This way, all devices that support the standard (e.g., VVC) can decode the encoded video data. Compression can be lossless, i.e., the decoded video will be identical to the source video given to the encoder, or lossy, where a certain degradation of content is accepted. Using lossy compression allows for significantly lower bit rates, i.e., the compression ratio can be much higher. This is because reproducing image noise perfectly can make lossless compression quite expensive.

A video sequence contains a sequence of pictures. A color space commonly used in video sequences is YCbCr, where Y is the luma (brightness) component and Cb and Cr are the chroma components. Sometimes the Cb and Cr components are called U and V. Other color spaces can also be used, such as ICtCp, IPT, constant-luminance YCbCr, RGB, YCoCg etc, and this disclosure is applicable also in these cases. The terms luma and chroma channels are sometimes used instead of luma and chroma components and are used interchangeably in this disclosure.

### 2. VVC, AV1, and HEVC

VVC and its predecessor HEVC are block-based video codecs standardized and developed jointly by ITU-T and MPEG. AV1 is another block based video codec specified by the Alliance for open media (AOM).

The codecs utilize both temporal and spatial prediction. VVC, AV1, and HEVC are similar in many aspects. Spatial prediction is achieved using intra (I) prediction from within the current picture. Temporal prediction is achieved using uni-directional (P) or bi-directional inter (B) prediction on the block level from previously decoded reference pictures. In the encoder, the difference between the original pixel data and the predicted pixel data, referred to as the residual, is transformed into the frequency domain, quantized and then entropy coded before transmitted together with necessary prediction parameters such as prediction mode and motion vectors, which also are entropy coded. The terms pixels, pixel values, samples, and sample values are in this disclosure used interchangeably. The decoder performs entropy decoding, inverse quantization and inverse transformation to obtain the residual, and then adds the residual to the intra or inter prediction to reconstruct a picture. The VVC version 1 specification was published as Rec. ITU-T H.266|ISO/IEC 23090-3, “Versatile Video Coding”, in 2020.

Exploratory work is ongoing for the next generation video codec in the joint JVET collaboration between ITU-T and ISO/IEC, with one track for traditional coding tools in the enhance compression model (ECM) software and one track for neural network (NN) coding tools. AOM is also working on a successor to the AV1 video codec, likely to be called AV2.

### 3. Blocks and Units

In many video coding standards, such as HEVC, AV1, and VVC, each component is split into blocks and the coded video bitstream consists of a series of coded blocks. A block is a two-dimensional array of values (e.g., sample values). It is common in video coding that the picture is split into units that cover a specific area of the picture. Each unit consists of all blocks from all components that make up that specific area and each block belongs fully to one unit. The macroblock in H.264 and the Coding Unit (CU) in HEVC and VVC are examples of units.

A transform used in coding can be applied to a block and these blocks are known under the name “transform blocks”. Also, a single prediction mode can be applied to a block and these blocks can be called “prediction blocks”.

### 4. VVC Block Structure

The VVC video coding standard uses a block structure referred to as quadtree plus binary tree plus ternary tree block structure (QTBT+TT) where each picture is first partitioned into square blocks called coding tree units (CTU). The size of all CTUs is identical and the partition is done without any syntax controlling it. Each CTU is further partitioned into coding units (CU) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape.

The depth of the quad tree and binary tree can be set by the encoder in the bitstream. The ternary tree (TT) part adds the possibility to divide a CU into three partitions instead of two equally sized partitions; this increases the possibilities to use a block structure that better fits the content structure in a picture. A CTU may comprise one or three coding tree blocks (CTBs) where each of the CTBs contain an N×N block of samples for a channel. For mono coded video with only one channel each CTU only comprises one CTB whereas for a YCbCr coded video each CTU comprises one luma CTB and two chroma CTBs. The chroma CTBs may be spatially subsampled compared to the luma CTB, e.g. by a factor of two in vertical and horizontal directions. In the text below, when referring to the size of a CTU the size of the luma CTB is sometimes used, which is equivalent.

### 5. Parameter Sets

HEVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g., data for multiple scalability layers in the bitstream.

VVC also specifies the PPS, the SPS and the VPS and one additional parameter set, the adaptation parameter set (APS). The APS in VVC carries parameters needed for the adaptive loop filter (ALF) tool, the luma mapping and chroma scaling (LMCS) tool and the scaling list tool.

Both HEVC and VVC allow certain information (e.g., parameter sets) to be provided by external means. “By external means” should be interpreted such that the information is not provided in the coded video bitstream but by some other means not specified in the video codec specification, e.g., via metadata possibly provided in a different data channel, as a constant in the decoder, or provided through an API to the decoder.

In AV1, a sequence header is used, which is similar to SPS.

### 6. NAL Units

Both VVC and HEVC define a Network Abstraction Layer (NAL). All the data, i.e. both Video Coding Layer (VCL) or and non-VCL data in HEVC and VVC is encapsulated in a NAL unit. A VCL NAL unit contains data that represents picture sample values such as coded slices. A non-VCL NAL unit contains additional associated data such as parameter sets and supplemental enhancement information (SEI) messages. The NAL unit in VVC and HEVC begins with a header called the NAL unit header. A NAL unit type syntax element nal_unit_type indicates and specifies how the NAL unit should be parsed and decoded. The bytes after the NAL unit header are the payload of the type indicated by the NAL unit type. A bitstream consists of a series of concatenated NAL units.

### 7. Open Bitstream Units (OBUs)

NAL units in AV1 are called Open bitstream units (OBUs). Similar to HEVC and VVC, all AV1 data is encapsulated in OBUs and an AV1 bitstream consists of a series of concatenated OBUs. The OBU begins with a header called obu_header( ) that includes a code word, obu_type, that specifies the type of the OBU. These are equivalent to the nal_unit_header( ) and nal_unit_type in VVC and HEVC. The OBU type identifies the type of data that is carried in the OBU and specifies how the OBU should be parsed and decoded.

### 8. Slices and Tiles

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of CTUs.

The VVC, AV1, and HEVC video coding standards include a tool called tiles that divides a picture into rectangular spatially independent regions. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In AV1, the tile group corresponds to a slice. A tile group OBU in AV1 contains an integer number of coded tiles. In an early draft of the VVC specification, slices were referred to as tile groups.

### 9. Picture Header

In VVC, a coded picture contains a picture header (PH) structure. The picture header structure contains syntax elements that are common for all slices of the associated picture. The picture header structure may be signaled in its own non-VCL NAL unit with NAL unit type PH_NUT or included in the slice header given that there is only one slice in the coded picture. For a CVS where not all pictures are single-slice pictures, each coded picture must be preceded by a picture header that is signaled in its own NAL unit. HEVC does not support picture headers. The equivalent header in AV1 is referred to as a frame header.

### 10. Subpictures

Subpictures are supported in VVC where a subpicture is defined as a rectangular region of one or more slices within a picture. This means a subpicture contains one or more slices that collectively cover a rectangular region of a picture. In VVC, subpicture location and size are signaled in the SPS. Boundaries of a subpicture region may be treated as picture boundaries (excluding in-loop filtering operations) conditioned to a per-subpicture flag subpic_treated_as_pic_flag[i] in the SPS. Also loop-filtering on subpicture boundaries is conditioned to a per-subpicture flag loop_filter_across_subpic_enabled_flag[i] in the SPS.

Bitstream extraction and merge operations are supported through subpictures in VVC and could for instance comprise extracting one or more subpictures from a first bitstream, extracting one or more subpictures from a second bitstream and merging the extracted subpictures into a new third bitstream.

### 11. Loop Filtering in VVC

VVC contains three in-loop filters that are not based on neural networks: A deblocking filter, a sample adaptive offset (SAO) filter, and an adaptive loop filter (ALF). The deblocking filter is used to remove block artifacts by smoothening discontinuities in horizontal and vertical directions across block boundaries. The deblocking filter uses a block boundary strength (BS) parameter to determine the filtering strength. The BS can have values 0, 1, and 2, where a larger value indicates a stronger filtering. The output of the deblocking filter is further processed by the SAO filter, and the output of SAO is then processed by ALF.

The output of ALF can then be put into the decoded picture buffer (DPB), which contains decoded pictures that may be used for prediction of subsequently encoded (or decoded) pictures. Since the deblocking filter, the SAO filter and ALF in this way influence the pictures in the DPB used for prediction, they are classified as in-loop filters, also known as loop filters. This means that changes done by the loop filter may influence not only the current picture but future pictures. It is possible for a decoder to further filter the picture in the DPB, but not store the filtered output in the DPB. In contrast to loop filters, such a filter is not influencing future predictions and is therefore classified as a post-processing filter, also known as a postfilter. Postfiltering is generally optional for decoders and thereby not required to be performed for decoder implementations to conform to a standard specification.

In ECM, the bilateral filter (BIF) has also been added. The filter is carried out in the sample adaptive offset (SAO) loop-filter stage and uses samples from deblocking as input. In ECM, each of the BIF and SAO filters creates an offset per sample, and these are added to the input sample and then clipped.

Another loop-filter that was considered in the development of VVC is the Hadamard filter.

### 12. Virtual Boundaries

Virtual boundaries in VVC are boundaries within pictures where the in-loop filter operations that would apply across the boundaries are disabled. The virtual boundary signaling in VVC allows turning off in-loop filtering at signaled positions within the coded pictures that do not have to be aligned with the CTU boundaries. The disabled in-loop filter operations include all of deblocking, SAO and ALF across the boundary. In VVC, there may be at most 3 virtual boundaries in the horizontal and 3 virtual boundaries at the vertical directions and the locations of virtual boundaries are signalled either in the SPS or in the PH. A virtual boundary in VVC must be placed on an 8×8 luma sample grid. In one example, for coding 360° video, when the 360° video uses a particular projection format that introduces discontinuities, virtual boundaries allow disabling of in-loop filtering across these boundaries without the need for content scaling to align projection discontinuities and CTU boundaries. Other use cases for virtual boundaries are region-of-interest (ROI) tiles and the GDR feature.

### 13. Gradual Decoding Refresh

VVC supports gradual decoding refresh (GDR) as an alternative to Intra picture refresh. In the bitstream, GDR is indicated by a GDR picture and a delta picture order count (POC) value. The delta POC value is used to identify when the video is fully refreshed. The first picture that is fully refreshed is called the recovery point picture. There may be pictures in-between the GDR picture and the recovery point picture. These pictures are called recovering pictures.

A GDR random-access operation starts by decoding the GDR picture. The GDR picture is typically coded using a mix of Intra and Inter blocks such that the Intra blocks provide a refreshed region, also called “clean area” when decoded. The Inter blocks may refer to decoded pictures that the decoder does not have, but VVC specifies that decoding shall proceed anyway. The VVC specification says these unavailable decoded pictures should be generated and the sample values of those pictures should be set to a mid value. The decoded unrefreshed area is commonly referred to as “the dirty area”. The border between the refreshed/clean area and the unrefreshed/dirty area may be referred to as the GDR boundary. The encoder constructs the bitstream such that the clean area increases in size by each decoded recovering picture until the recovery point picture.

When performing a GDR random-access operation, the decoder does not output the GDR picture or recovering pictures to avoid output of unrefreshed pictures. A special case is if the GDR picture is the same picture as the recovery point picture.

GDR pictures may be provided at regular intervals in a bitstream. This means that a decoder may first perform a GDR random-access operation, and thereafter decode many succeeding GDR pictures without performing random-access on any of them. Note that the samples in the clean area will get the same value when a GDR random-access operation is performed and when the video is continuously decoded. However, the sample values in the dirty area may differ for the two cases.

When GDR is used in VVC, a virtual boundary may be signalled for the GDR boundary. This disables in-loop filtering across the regions which prohibits sample values from a dirty region to affect samples in a clean region through filtering.

When a GDR random-access has been done, the sample values of the decoded recovery point picture must be identical to the samples values that would be decoded at continuous decoding. It is the responsibility of the encoder to ensure that this is always the case. To do this, the encoder needs to ensure that no information from the dirty area is referred to when decoding clean area sample values, for example in motion compensation and in-loop filtering processes. Typically, Intra coded block columns or block rows are used to progressively refresh the video.

Virtual boundaries can in this example be used to disable in-loop filtering between the Intra/clean area and the dirty area. Note that for the example above, it would be fine to allow the dirty area to refer to the Intra/clean area but not the other way around. The VVC specification does not distinguish between clean and dirty areas, in-loop filtering is disabled both ways.

In contrast to VTM, which is the reference software for VVC, the ECM experimental software is aware of the clean and dirty areas. This was adopted from proposal JVET-Z0118. ECM doesn't include any new syntax elements compared to VTM. Instead, it relies on virtual boundary signalling and assumes a left-to-right wipe when GDR is used.

Proposal JVET-AE0145 suggested to modify the ECM GDR method to add a 1-bit flag per virtual boundary that would signal what side of the virtual boundary that is dirty and what side that is clean. The presence of this flag would be conditioned on the picture type; if the picture is a GDR picture or a recovering picture, the flag would be present, otherwise it would not be present. Proposal JVET-AE0145 was not adopted into the ECM software.

### 14. Exploration Experiment on Neural Network Based Video Coding (NNVC)

At the 20th JVET meeting it was decided to set up an exploration experiment (EE) on neural network-based (NN-based) video coding. The exploration experiment continued at the subsequent JVET meetings 21 through 35 with many tests: NN-based in-loop filtering, NN-based post filtering, NN-based super resolution and NN-based intra prediction. The first test is most relevant to this disclosure and is described further.

The contributions JVET-X0066 and JVET-Y0143 are two successive contributions that describe NN-based in-loop filtering. Both contributions use the same NN models for filtering. The NN-based in-loop filter is placed before SAO and ALF and the sample values before the deblocking filter are used as input to the filter. The output of the NN-based in-loop filter is mixed (blended) with the output of the deblocking filter and forwarded as the input to SAO. The purpose of using the NN-based in-loop filter is to improve the quality of the reconstructed samples. Here it is helpful that the NN model is non-linear. While deblocking, SAO and ALF all contain non-linear elements such as conditions, and are thus not strictly linear, all three of them are based on linear filters. In contrast, a sufficiently large NN model can in principle learn any non-linear mapping and is therefore capable of representing a wider class of functions compared to deblocking, SAO and ALF. In JVET-X0066 and JVET-Y0143, there are four NN models, i.e., four NN-based in-loop filters. In a refined version of that work presented in the contribution JVET-AB0052, only two models are used: One model for luma samples and another model for chroma samples.

Contribution JVET-AD0380 proposed a new unified design for the NN-based in-loop filtering, which captures the benefits of previous NN structures. The unified filter has only one NN model, to filter luma and chroma samples and intra and inter pictures. The unified filter takes six inputs: the reconstructed samples of luma and chroma before deblocking (‘rec’), the prediction samples of luma and chroma (‘pred’), the deblocking block boundary strength (BS) information of luma and chroma (‘bs’), the quantization parameter for a sequence (‘QPbase’), the quantization parameter for each slice (‘QPslice’), as well as information on whether a particular sample was intra-predicted, uni-predicted or bi-predicted (‘IPB’). These inputs first go through a convolutional layer (3×3 or 1×1) and a parametric rectified linear unit (PReLU) layer separately, then they are concatenated and fused together with a 1×1 convolutional layer.

The NN-based in-loop filters presented in JVET-X0066, JVET-AB0053, JVET-AB0052 and JVET-AD0380 increase the compression efficiency of the codec substantially, i.e., they lower the bit rate substantially without lowering the objective quality as measured by MSE-based PSNR. Increases in compression efficiency, typically referred to simply as “gain”, are often measured as the Bjontegaard-delta rate (BDR) against an anchor. As an example, a BDR of −1% means that the same PSNR distortion can be reached with 1% bitrate saving on average. As reported in JVET-AF0041, for the random access (RA) configuration, the BDR for the luma component (Y) is −10.27%, and for the all-intra (AI) configuration, the BDR for the luma component is −7.86%. The complexity of NN models used for compression are often measured by multiply-accumulate operations per pixel (MAC/pixel). The high bitrate savings of an NN model is typically directly related to the complexity of the NN model. The model described in JVET-AF0041 has a complexity of 477 kMAC/pixel, i.e., 477,000 multiply-accumulate operations per pixel. There are also other measures of complexity, such as total model size in terms of stored parameters.

To further investigate the tradeoff between the compression efficiency and complexity of the NN-based in-loop filters, new operation points have been introduced. The two new operation points are: (1) a low operation point (LOP), with a complexity of about 17 kMAC/pixel, and (2) a very low operation point (VLOP), with a complexity of about 5 kMAC/pixel.

A Low Operation Point (LOP) architecture NN loop filter used in a JVET EE test (EE1-1.0) is illustrated in FIG. 1 from JVET-AG2023. In FIG. 1 from JVET-AG2023 the input patch size is 144×144 and there is a final cropping step that crops 8 pixels from each side of the output luma patch and 4 pixels from each side of each chroma patch (which has half the size of the luma patch). Hence the final patch size after cropping in the output is equal to 128×128 for luma and 64×64 for the chroma branch. The complexity of this current model is about 17 kMAC per sample. This means that about 17,000 multiplications are performed for calculating one sample value in the output of neural network loop filter architecture in FIG. 1 of JVET-AG2023.

The architecture of VLOP is similar to LOP, but the complexity is only about 5 kMAC/pixel. Compared to LOP, VLOP has a smaller number of backbone blocks and channels.

In JVET standardization, development and study of codecs is done using common test conditions (CTC). The CTC specifies how a codec under test should be configured and what test sequences should be used. Keeping the test conditions static enables apples-to-apples evaluations, but with the drawback that configurations outside the CTC are not tested much and the codec performance may become too optimized towards the CTC.

Because the luma and chroma components of the sample values are usually input to the neural network as separate input channels, it is common to refer to luma and chroma component as luma and chroma channels as well. The terms luma or chroma channels and luma or chroma components may be hence used interchangeably in this document.

### 15. NNVC 10.0 Syntax and Semantics

The focus of this section is on the NN architecture in NNVC-10.0, which is the current available version of the software. Note that there is no specification text containing the syntax and semantics shown in this section, but the following is based on the NNVC software available on the following HHI repository https://vcgit.hhi.fraunhofer.de/jvet-ahg-nnvc/VVCSoftware_VTM where the NNVC-10.0 software is tagged as v10rc.

### 15.1. Sequence Parameter Set

The syntax table below is derived from NNVC-10.0 when NN_LF_UNIFIED=1.

| | De- |
|---|---|
| | scriptor |
| seq_parameter_set_rbsp( ) { | |
| ... | |
| sps_nnlf_enabled_flag | u(1) |
| if( sps_nnlf_enabled_flag ) | |
| sps_nnlf_model_id | ue(v) |
| if( sps_nnlf_enabled_flag && (sps_nnlf_model_id == 3 \| \| | |
| sps_nnlf_model_id == 4 \| \| sps_nnlf_model_id == 5) ) { | |
| sps_nnlf_unified_infer_size_base | ue(v) |
| sps_nnlf_unified_inf_size_ext | ue(v) |
| sps_nnlf_unified_max_num_prms | ue(v) |
| ... | |
| } | |
| ... | |
| sps_nn_intra_pred_enabled_flag | u(1) |
| ... | |
| } | |

The semantics of the syntax elements shown above are described below.

sps_nnlf_enabled_flag equal to 1 specifies that NN in-loop filtering is enabled for the CLVS. sps_nnlf_enabled_flag equal to 0 specifies that NN in-loop filtering is disabled for the CLVS.

sps_nnlf_model_id equal to 0 specifies that NN in-loop filtering set 0 may be used. sps_nnlf_model_id equal to 1 specifies that NN in-loop filtering set 1 may be used. sps_nnlf_model_id equal to 2 specifies that the LOP1 in-loop filtering may be used. sps_nnlf_set equal to 3 specifies that the HOP or LOP in-loop filtering may be used. sps_nnlf_model_id equal to 4 specifies that LOP3 in-loop filtering may be used and sps_nnlf_model_id equal to 5 specifies that HOP4 in-loop filtering may be used.

sps_nnlf_unified_infer_size_base specifies the base inference size of NN-based in-loop filter. When not present in the bitstream the value of sps_nnlf_unified_infer_size_base is inferred to be equal to 128.

sps_nnlf_unified_inf_size_ext specifies the extension of inference size of NN-based in-loop filter. When not present in the bitstream the value of sps_nnlf_unified_inf_size_ext is inferred to be equal to 8.

sps_nnlf_unified_max_num_prms specifies the number of the conditional parameters of the NN-based in-loop filter. When not present in the bitstream the value of sps_nnlf_unified_max_num_prms is inferred to be equal to 2.

sps_nn_intra_pred_enabled_flag equal to 1 specifies that NN intra prediction tool is enabled for the CLVS. sps_nn_intra_pred_enabled_flag equal to 0 specifies that NN intra prediction tool is disabled for the CLVS.

Further in the NNVC-10.0 software, if the slice is an I slice, the patch size will be set equal to sps_nnlf_unified_infer_size_base<<1 where <<1 is a left shift doubling the signalled value. Further in the NNVC-10.0 software, if the slice is not an I-slice, for QP<29 the patch size will be set equal to sps_nnlf_unified_infer_size_base, and if QP≥29, the patch size will be set equal to sps_nnlf_unified_infer_size_base if the picture width is smaller than 823, and to sps_nnlf_unified_infer_size_base<<1 for wider pictures, i.e., if the picture width is larger than or equal to 823.

### 15.2. Slice Header

The syntax table below for the slice header is derived from NNVC-10.0.

| | Descriptor |
|---|---|
| slice_header( ) { | |
| ... | |
| if( sps_nnlf_enabled_flag && (sps_nnlf_model_id == 3 ∥ | |
| sps_nnlf_model_id == 4 ∥ sps_nnlf_model_id == 5)) { | |
| slice_nnlf_unified_mode | ue(v) |
| if( slice_nnlf_unified_mode > 0 ) { | |
| slice_nnlf_unified_scale_flag | ue(v) |
| if(slice_nnlf_unified_scale_flag ) { | |
| if( slice_nnlf_unified_mode < sps_nnlf_unified_max_num_prms ) { | |
| y_nnScale | u(v) |
| cb_nnScale | u(v) |
| cr_nnScale | u(v) |
| else | |
| for (prmld = 0 ; prmld < sps_nnlf_unified_max_num_prms ; | |
| prmld++ ) { | |
| y_nnScale | u(v) |
| cb_nnScale | u(v) |
| cr_nnScale | u(v) |
| } | |
| } | |
| } | |
| } | |
| } | |
| ... | |
| } | |

The semantics of the syntax elements shown above are described below.

slice_nnlf_unified_mode equal to 0 specifies that no filtering is done for the slice. slice_nnlf_unified_mode equal to 1 specifies that filtering is done with prmId equal to 0 for all NN blocks in the slice. slice_nnlf_unified_mode equal to 2 specifies that filtering is done with prmId equal to 1 for all NN blocks in the slice. slice_nnlf_unified_mode equal to 3 specifies that prmId is decoded for each NN block in the slice.

slice_nnlf_unified_scale_flag equal to 1 specifies that there are scaling factors in the bitstream for NN in-loop filtering. slice_nnlf_unified_scale_flag equal to 0 specifies that no scaling factor for NN in-loop filtering is signalled in the bitstream.

y_nnScale specifies the Y component of the NN in-loop filter scale factor.

cb_nnScale specifies the Cb component of the NN in-loop filter scale factor.

cr_nnScale specifies the Cr component of the NN in-loop filter scale factor.

### 15.3. Residue Scaling

In the NNVC-10.0 software, when the NN loop filter is applied to reconstructed pictures, a scaling factor is derived and signaled for each color component in the slice header (see the syntax table above). The derivation is based on least square method. The difference between the input samples and the NN filtered samples (residues) are scaled by the scaling factors before being added to input samples.

### SUMMARY

Certain challenges presently exist. For instance, in the ongoing exploration experiments on NN based video coding (EE1) in JVET, the high-level syntax aspect for NN loop filters seems currently underexplored. EE1 looks into few NN loop filter design points (operation points) and architectures (e.g. HOP, LOP and VLOP models), each taking in inputs and providing output in particular formats (see for instance item 14 above for some examples) while interacting with other parts of—or mechanisms in—the encoder and decoder using few defined options.

At the current state it seems that there is a lack of high-level syntax mechanisms for governing the cases where an NN based loop filter interacts with other known concepts or mechanisms in block-based image or video codecs. Some of these concepts or mechanisms are picture blocks and units (CTU, CU, DU, etc.), picture partitioning mechanisms (slices, tiles, subpictures, etc.), wavefront coding, virtual boundaries, other existing loop filters, etc. As a result, the interaction of the NN loop filters with other concepts and mechanisms in place may not be well exploited, for instance towards higher coding gains, lower computational complexity, or codec configurations flexibility.

Moreover, some of the high-level signalling aspects of the state-of-the-art NN loop filters, such as the ones under exploration in JVET EE1, have more of an experimental nature. Hence these aspects may not be flexible, efficient, or diverse enough to fully utilize the benefits of the NN loop filters.

For instance, some of the interactions between the NN loop filters and established concepts and mechanisms in high-level signalling of the NN loop filters under exploration might have implications on the training of the NN loop filters as well, which are not currently considered. For instance, the choice of the padding for margins of the input patch to the NN loop filter might have high-level signalling costs (for instance if the choice of the padding size needs to be signalled) and may also affect the training process of the neural network loop filter by, for instance, affecting the creation of the training set, e.g. including two padding sizes for each input sample which will double the size of the training set, while providing compression gain. Hence the governance of the interactions between the NN loop filter and other stablished concepts and mechanisms in the encoder and decoder should take the training aspects into account, which is not currently the case.

Accordingly, in one aspect there is provided a method for decoding one or more pictures from a bitstream, the one or more pictures comprising a first picture. The method includes obtaining patch information for the first picture. The method also includes generating a first input patch using the patch information for the first picture. The method also includes applying a neural network, NN, filter to the first input patch, thereby generating a first output patch, The method also includes decoding the first picture and/or one or more other pictures of the one or more pictures using the first output patch.

In another aspect there is provided a method for encoding one or more pictures in bitstream, the one or more pictures comprising a first picture. The method includes obtaining patch information for the first picture. The method also includes generating a first input patch using the patch information for the first picture. The method also includes applying an NN filter to the first input patch, thereby generating a first output patch. The method also includes encoding the first picture and/or one or more other pictures of the one or more pictures using the first output patch.

In some aspects, there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that they improve performance, decrease complexity, increase flexibility and/or decrease energy consumption of the codec by regulating the interaction of the NN loop filter with the rest of the codec. For example, the applicability of the NN loop filters is extended, in some embodiments, to more pictures or parts of pictures in the bitstream by designing the mechanisms that are required but not existing yet for applicability of the NN loop filters to those extra pictures or picture areas; this is beneficial because NN loop filters have shown a good potential in improving the compression efficiency in image and video codecs.

In addition, regulating, harmonizing, and facilitating the interaction of the NN loop filter with other concepts and mechanisms in a block-based image or video codec through high-level mechanisms improve the overall performance of the codec by more timely usage of the NN loop filters and usage of the NN loop filters with the right input and settings. The proposed solutions could also simplify the architecture and/or affect the training of the NN loop filter indirectly.

A simpler network, either with smaller number of parameters in the network or lower number of computations for each sample value being output from the neural network, may be achieved by, for instance, trading off some of the compression efficiency gained by the proposed solution. The flexibility given by the signalling of the patch sizes allows the encoder to fine-tune complexity vs performance of applying the NN loop filter, wherein the patch sizes may for instance be set based on the available resources or be based on the complexity or characteristics of the content itself.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 is a schematic block diagram of a loop filter stage (LFS) according to an embodiment.

FIG. 5 illustrates an input block and an input patch according to an embodiment.

FIG. 6 illustrates a picture having multiple NN blocks according to an embodiment.

FIG. 7 shows a picture and its NN blocks according to an example.

FIG. 8 illustrates two example patch size embodiments.

FIG. 9 is a flowchart illustrating a process according to an embodiment.

FIG. 10 is a flowchart illustrating a process according to an embodiment.

FIG. 11 is a block diagram of an encoding apparatus according to an embodiment.

### DETAILED DESCRIPTION

### Terminology:

The following terminology is used herein:

| Term | Description |
|---|---|
| NN block | Block of elements with sample values (e.g. 128 × 128) in the picture |
| | used by the NN for the NN filtering |
| Border area | Area in the picture around the NN block |
| Patch | Block of elements with values that is input to the NN or output from |
| | the NN. The NN takes an input patch (which may also be called a |
| | “neural network patch”) and produces an output patch. An input |
| | patch could be with or without a margin. An output patch could be |
| | with or without cropping. |
| Central area | Input patch minus margin. The central area of the input patch has the |
| | same size as the NN block. |
| Margin | Part of the patch outside the central area. Comprises border area |
| | sample values or non-sample padding values |
| Padding | When used as a verb means to assign padding values to one or more |
| | elements of the input patch |
| | When used as a noun means a padding value or padding values |
| | assigned to one or more elements of the input patch |
| Padding value | Either a sample padding value or a non-sample padding value |
| Sample padding | Means to assign sample padding values to one or more elements of |
| | the input patch |
| Sample padding | Values of collocated samples in the corresponding input block |
| value | |
| Non-Sample | Means to assign non-sample padding values to one or more elements |
| padding | of the input patch |
| Non-sample | Any value that is not a sample padding value. A patch element may be |
| padding value | assigned either a sample padding value or non-sample padding value. |
| | Examples of non-sample padding values include: |
| | zeros (or other constant values) |
| | replication values (e.g. replication of the border sample values) |
| | extrapolated values |
| | sample values from non-collocated elements |
| | filtered sample values from collocated or non-collocated samples |
| | from the input block |
| Input block | Area in the picture having the same size as the input patch |
| | corresponding to the NN block |

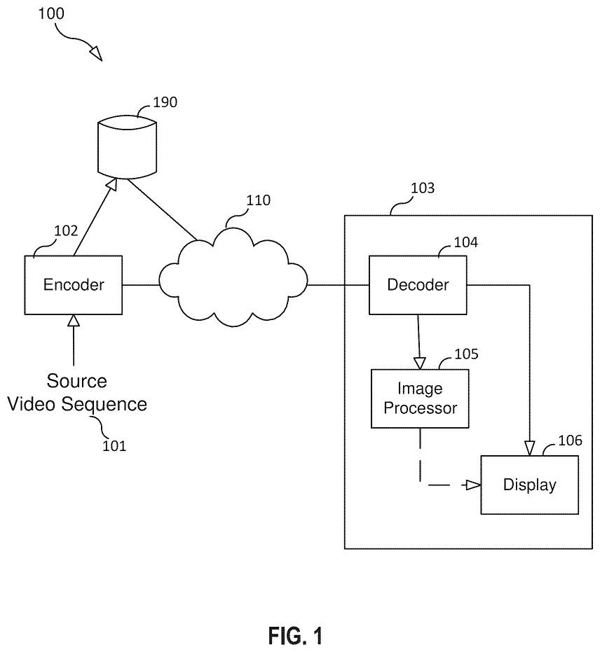

FIG. 1 illustrates a system 100 according to an embodiment. System 100 includes an encoder 102 and a decoder 104. In some embodiments, encoder 102 is in communication with decoder 104 via a network 110 (e.g., the Internet or other network). Encoder 102 encodes a source video sequence 101 into a bitstream comprising an encoded video sequence and may transmit the bitstream to decoder 104 via network 110. In some embodiments, encoder 102 is not in communication with decoder 104, and, in such an embodiment, rather than transmitting bitstream to decoder 104, the bitstream is stored in a data storage unit 190 and decoder 104 retrieves from the data storage unit 190 the bitstream containing the encoded video sequence. Data storage unit 190 may be collocated with encoder 102 or may be remote from encoder 102.

Decoder 104 decodes the pictures included in the encoded video sequence to produce decoded video data for display and/or post processing (e.g. a machine vision task). Accordingly, decoder 104 may be part of a device 103 having an image processor 105 (e.g., a postfilter or other image processor) and/or a display 106. The image processor 105 may perform machine vision tasks on the decoded pictures. One such machine vision task may be identifying an object in the picture and creating a 3D model of the object. The image processor 105 may also comprise or consist of a postfilter, such as a neural network postfilter (NNPF), that that may receive reconstructed pictures from decoder 104 and that may process the reconstructed pictures using a specified postfilter. In the embodiment shown, processor 105 is separate from decoder 104, but in other embodiments, processor 105 may be a component of decoder 104. The device 103 may be a mobile device, a set-top device, a head-mounted display, or any other device.

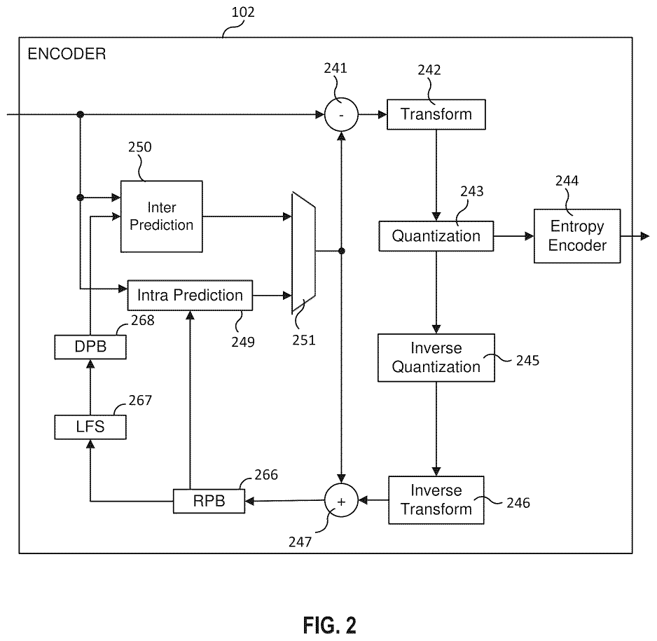

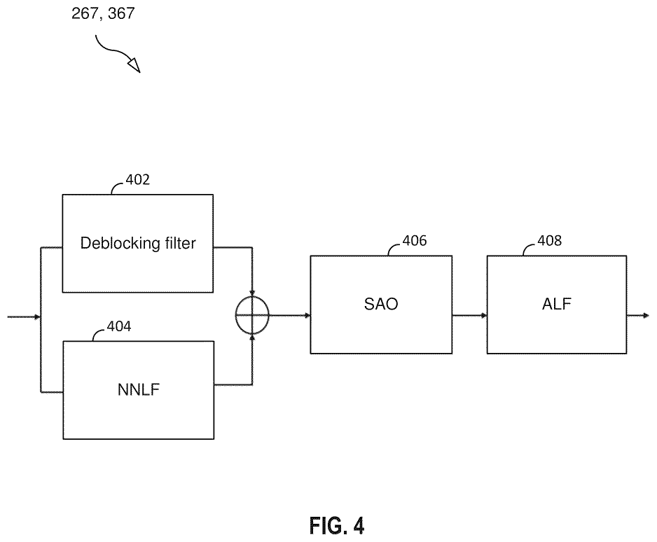

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in sample values between an input block and a prediction block (i.e., the output of a selector 251, which is either an inter prediction block output by an inter predictor 250 (a.k.a., motion compensator) or an intra prediction block output by an intra predictor 249). Then a forward transform 242 is performed on the residual block to produce a transformed block comprising transform coefficients. A quantization unit 243 quantizes the transform coefficients based on a quantization parameter (QP) value (e.g., a QP value obtained based on a picture QP value for the picture in which the input block is a part and a block specific QP offset value for the input block), thereby producing quantized transform coefficients which are then encoded into the bitstream by encoder 244 (e.g., an entropy encoder) and the bitstream with the encoded transform coefficients is output from encoder 102. Next, encoder 102 uses the quantized transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstructed picture buffer (RPB) 266. Loop filtering by a loop filter stage (LFS) 267 is applied and the final decoded picture is stored in a decoded picture buffer (DPB) 268, where it can then be used by the inter predictor 250 to produce an inter prediction block for the next picture to be processed. As illustrated in FIG. 4, LFS 267 may include multiple sub-stages: i) a deblocking filter 402, ii) an NN loop filter 404 (a.k.a., “NN loop filter (NNLF)”), iii) a sample adaptive offset (SAO) filter 406, and iv) an adaptive loop filter (ALF) 408.

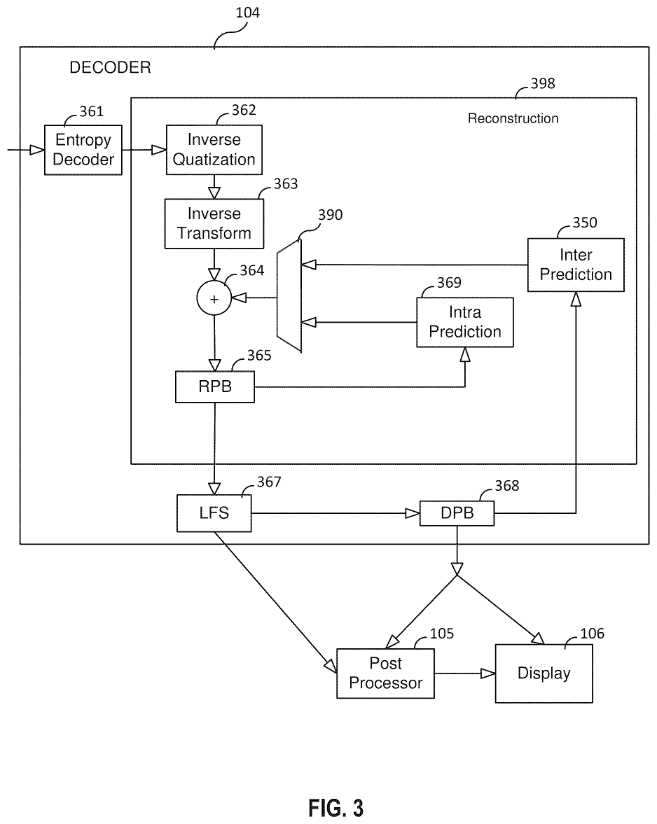

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream quantized transform coefficient values of a block. Decoder 104 also includes a reconstruction stage 398 in which the quantized transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a RPB 365. The inter prediction block is generated by the inter prediction module 350 and the intra prediction block is generated by the intra prediction module 369. Following the reconstruction stage 398, an LFS (loop filter stage) 367 applies one or more filters to the reconstructed blocks and the final decoded picture may be stored in a decoded picture buffer (DPB) 368 and output to post processor 105 for post processing and/or display 106. Pictures are stored in the DPB for two primary reasons: 1) to wait for picture output and 2) if the picture is a reference picture, to be used for reference when decoding future pictures. In some embodiments, post processor 105 may receive the reconstructed picture before all loop filters are applied.

FIG. 4 illustrates LFS 267 and LFS 367 according to one embodiment. In the embodiment shown, the LFS includes: i) a deblocking filter 402, ii) an NNLF 404, iii) a sample adaptive offset (SAO) filter 406, and iv) an adaptive loop filter (ALF) 408. As shown in FIG. 4, NNLF 404 is placed before SAO 406 and ALF 408 and the sample values before the deblocking filter 402 are used as input to NN-based filter 404. In this embodiment, the output of NN-based filter 404 is mixed (blended) with the output of deblocking filter 402 and forwarded as the input to SAO 406. Using NN-based filter 404 in this way serves to improve the quality of the reconstructed samples. In some embodiments, the blending of the outputs from deblocking filter 402 and NN filter 404 is expressed as: R=w×R_{NN}+(1−w)×R_{DB}, where R is the result after blending, R_{NN} and R_{DB} are the outputs from NN filter 404 and deblocking filter 402, respectively, and w is a weight factor from a set of predefined weights. The weight factor may be signalled per NN block.

As described above, a challenge presently exists because the conventional governance of the interactions between an NN loop filter and other stablished concepts and mechanisms in the encoder and decoder do not take into account the training aspects.

Accordingly, in some embodiments, this disclosure introduces, in one embodiment, novel syntax elements and methods for using those novel syntax elements for governing the usage of the NN-based loop filter and its interaction with other tools, mechanisms and parts of the codec. In one embodiment from the decoder's perspective, the decoder obtains information about the patch size, either by decoding it from the bitstream or deriving it, and using the obtained patch size information for decoding the picture. The information may describe the size of the patch to be used by the NN loop filter or limitations (e.g., size constraints), such as e.g. a maximum or minimum patch size, that could determine whether to apply the NNLF or not.

### Additional Description

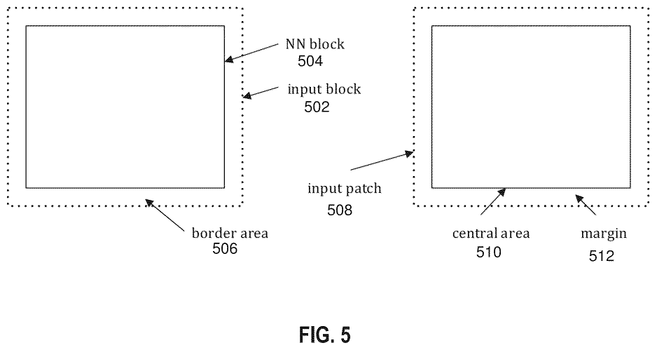

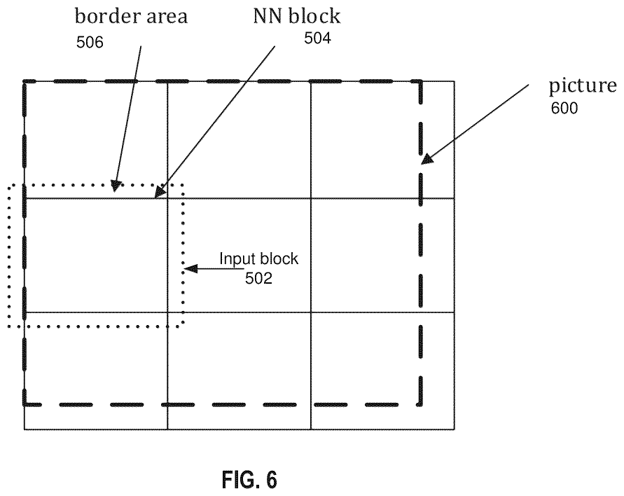

FIG. 5 illustrates an example input block 502 of a picture 600 (see FIG. 6) and an example input patch 508 corresponding to input block 502. Input block 502 includes an NN block 504 and a border area 506 that surrounds NN block 504. Some portion of the border area 504 of input block 502 may extend beyond picture 600 (see FIG. 6).

Input patch 508 includes a central area 510 and a margin area 512 that surrounds central area 510. At least some of the sample values for input patch 508 are derived using the sample values of input block 502. Input patch 508 is the block of sample values that will be processed by NNLF 404.

FIG. 6 illustrates input block 502 in relation to picture 600 to which the input block 502 belongs. As shown in FIG. 6, picture 600 may for example be divided into multiple NN blocks. In FIG. 6, the NN-blocks are marked with solid lines, the input block area is marked with dotted lines and the picture is marked in dashed lines. There could also be other ways of dividing the picture and extracting NN blocks, e.g. the NN blocks may be sparsely distributed, or they may be overlapping.

An input block, an NN block and an input patch may have multiple channels, e.g. one for luma and two for chroma. An input block, an NN block and an input patch may alternatively only comprise one of the channels. The size (or resolution) of the channels could be different, for instance the luma channel may have the size M×N but the chroma channels may have the size M/2×N/2.

As noted above, in a decoder embodiment, the decoder obtains patch information, such as information specifying (explicitly or implicitly) the patch size for the input patch input into the NNLF and/or the output patch produced by the NNLF, or information specifying limitations for the patch sizes (e.g., a patch size constraint). The patch information may be explicitly signalled in the bitstream or derived by the decoder from one or more syntax elements in the bitstream. One non-limiting example of patch information being explicitly signalled is when a syntax element in the bitstream exclusively represents a specific patch information value, and that is the sole purpose of that syntax element. The patch information may also be obtained or derived by external means. By “external means” should be interpreted such that the information is not provided in the coded video bitstream but by some other means not specified in the video codec specification, e.g., via metadata possibly provided in a different data channel, as a constant in the decoder, or provided through an API to the decoder.

In one embodiment, the specified patch size is relative to the CTU size. In other embodiments, the patch size is relative to a CU size or another block structure. In yet another version the patch size is in terms of luma samples.

In one embodiment, the signalled or derived patch information includes information specifying the size of the margin of the patch. In another embodiment, the signalled or derived patch information merely identifies the size of the central area of a patch, i.e. the size of the area collocated with the NN block in the picture. The margin could then be omitted, have a fixed size value, e.g. 8, or the margin size could be derived by other means, e.g. based on the patch size or explicitly signalled.

The following specific embodiments specify different aspects of this disclosure.

### 1. Patch Size Information

In this embodiment, patch size information (or “patch size” for short) is signalled per picture. For example, the patch size may be in a slice header or a picture header and/or in one or more parameter sets (e.g. APS, PPS, SPS or VPS). In one version, the patch size is signalled for parts of a picture. This may include signalling the patch size in a slice, in an APS with the APS identifier identifying the APS being signalled in a slice, or signalling the patch size per subpicture or tile. The patches may be constrained to have the same size within a slice, within a tile, within a subpicture, within a picture, within a group of pictures or within a sequence. The patches may alternatively have different sizes within a slice, within a tile, within a subpicture, within a picture, within a group of pictures or within a sequence. One reason for allowing different patch sizes may, for example, be differences in the details and complexity of the input pictures.

In one example, a size value is signalled in the picture header for the current picture, and the size of the input patches to NNLF 404 is the size value unless the patch is a border patch at the right or bottom border of the picture which then may have a smaller size. In this example, the size value specifies (explicitly or indirectly) the width and height of the input patch. Accordingly, in some embodiments, the size value is a vector that consists of two values: a width value and a height value.

In another example, the size of the input patch to NNLF 404 is specified relative to the CTU size. In one example, the size of the input patch to NNLF 404 is specified to be equal to the CTU size, and so for CTU sizes 256×256 the input patch to NNLF 404 is also 256×256 and for CTU sizes of 128×128 the input patch becomes 128×128.

Two examples of signalling the patch size in a parameter set, either as a size syntax element relative to CtbSizeY (equivalent to CTU size) or one width and one height syntax element relative to CtbSizeY, are described with the syntax and semantics below:

| | Descriptor |
|---|---|
| parameter_set_rbsp( ) { | |
| ... | |
| nn_patch_size_minus1 | ue(v) |
| } | |

nn_patch_size_minus1 plus 1 specifies the size of a neural network patch in units of CtbSizeY.

| | Descriptor |
|---|---|
| parameter_set_rbsp( ) { | |
| ... | |
| nn_patch_width_minus1 | ue(v) |
| nn_patch_height_minus1 | ue(v) |
| } | |

nn_patch_width_minus1 plus 1 specifies the width of a neural network patch in units of CtbSizeY.

nn_patch_height_minus1 plus 1 specifies the height of a neural network patch in units of CtbSizeY.

In another embodiment, the sizes of the patches in a picture may be different from each other. Two examples of signalling the patch sizes in a parameter set, either as a size syntax element per patch or explicit width and height syntax elements per patch, are described with the syntax and semantics below:

| | Descriptor |
|---|---|
| parameter_set_rbsp( ) { | |
| ... | |
| nn_num_patches_minus1 | ue(v) |
| for (i = 0; i <= nn_num_patches_minus1; i++) | |
| nn_patch_size_minus1[ i ] | ue(v) |
| } | |

nn_num_patches_minus1 plus 1 specifies the number of neural network patches.

nn_patch_size_minus1[i] plus 1 specifies the size of a neural network patch in units of CtbSizeY.

In this example, the position of the NN patches may be derived based on the raster-scan order, such that a next NN patch is assigned a position in the picture with its top left corner in the of the next empty sample in raster-scan order. In the example below, the position of the NN patches are explicitly signaled with the x- and y-coordinates for the top-left corner.

| | Descriptor |
|---|---|
| parameter_set_rbsp( ) { | |
| ... | |
| nn_num_patches_minus1 | ue(v) |
| for (i = 0; i <= nn_num_patches_minus1; i++) { | |
| nn_patch_width_minus1[ i ] | ue(v) |
| nn_patch_height_minus1[ i ] | ue(v) |
| nn_patch_pos_x_minus1[ i ] | ue(v) |
| nn_patch_pos_y_minus1[ i ] | ue(v) |
| } | |
| } | |

nn_patch_width_minus1[i] plus 1 specifies the width of the i-th neural network patch in units of CtbSizeY.

nn_patch_height_minus1[i] plus 1 specifies the height of the i-th neural network patch in units of CtbSizeY.

nn_patch_pos_x_minus1[i] plus 1 specifies the horizontal position of the i-th neural network patch in units of CtbSizeY.

nn_patch_pos_y_minus1[i] plus 1 specifies the vertical position of the i-th neural network patch in units of CtbSizeY.

In yet another version, the patch sizes for a picture are derived based on splits (e.g. quad or binary splits) of the NN-blocks. In a first example, the number of initial NN blocks is determined. Then, for at least one initial NN block X, information whether that NN block X is split or not is obtained.

| | Descriptor |
|---|---|
| parameter_set_rbsp( ) { | |
| ... | |
| for (i = 0; i < M ; i++ ) { | |
| nn_quad_split_flag | u(1) |
| ... | |
| } | |

nn_quad_split_flag equal to 1 specifies that the current NN block is split into 4 equally sized NN blocks. nn_quad_split_flag equal to 0 specifies that the current NN block is not split.

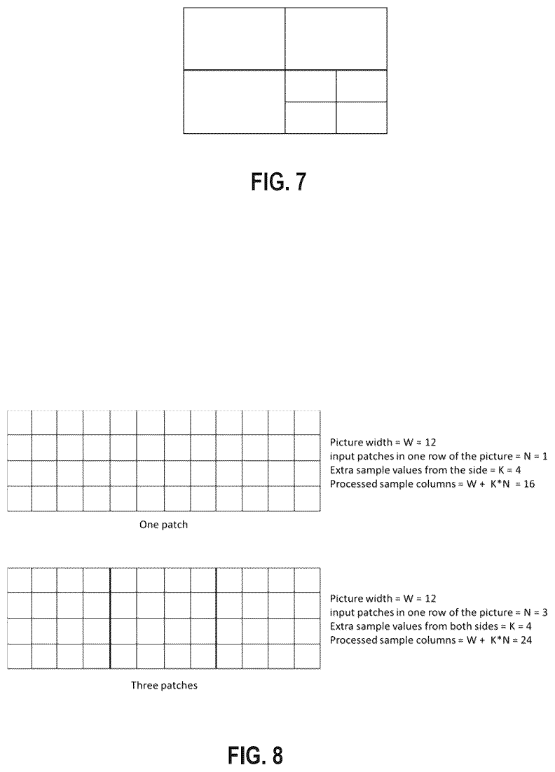

FIG. 7 shows a picture and its NN blocks. In this figure, there are 4 initial NN blocks, and the values of the nn_quad_split_flag syntax elements is equal to {0, 0, 0, 1}, meaning that only the bottom-right initial NN block is split.

In another example, the split flags are not decoded from a parameter set but decoded from the slice data as follows:

| | Descriptor |
|---|---|
| slice_data( ) { | |
| ... | |
| nn_quad_split_flag | ae(v) |
| ... | |

nn_quad_split_flag equal to 1 specifies that the current NN block is split into 4 equally sized NN blocks. nn_quad_split_flag equal to 0 specifies that the current NN block is not split.

In the above example, the number of initial NN blocks may not be determined. Instead, there is one nn_quad_split_flag for each initial NN block decoded from slice_data( ) The nn_quad_split_flag may be CABAC encoded. In one variant, the size of the initial NN blocks is equal to the CTU size, and in this variant there is one nn_quad_split_flag decoded for each CTU. It should be noted that, for these two examples, an NN block that is split may be further split.

In one version of this embodiment, the signaled patch size, patch width and patch height are for both the input patch and the output patch. In another version of this embodiment the patch size, patch width and patch height are signaled separately for each of the input patch and the output patch as described with the syntax and semantics below for the size syntax elements:

| | Descriptor |
|---|---|
| parameter_set_rbsp( ) { | |
| ... | |
| nn_input_patch_size_minus1 | ue(v) |
| nn_output_patch_size_minus1 | ue(v) |
| } | |

nn_input_patch_size_minus1 plus 1 specifies the size of a neural network input patch in units of CtbSizeY.

nn_output_patch_size_minus1 plus 1 specifies the size of a neural network output patch in units of CtbSizeY.

In another version of this embodiment, the signalling of the output patch size may be omitted if the output patch size is equal to the input patch size. This may be realized by signalling a flag that specifies that the output patch size is equal (or not equal) to the size of the input patch as described with the syntax and semantics below:

| | Descriptor |
|---|---|
| parameter_set_rbsp( ) { | |
| ... | |
| nn_input_patch_size_minus1 | ue(v) |
| nn_output_patch_size_equal_to_input_patch_size_flag | u(1) |
| if ( !nn_output_patch_size_equal_to_input_patch_size_flag ) | |
| nn_output_patch_size_minus1 | ue(v) |
| } | |

nn_input_patch_size_minus1 plus 1 specifies the size of a neural network input patch in units of CtbSizeY.

nn_output_patch_size_equal_to_input_patch_size_flag equal to 1 specifies that the size of the output patch is equal to the size of the input patch. nn_output_patch_size_equal_to_input_patch_size_flag equal to 0 specifies that the size of the output patch may not be equal to the size of the input patch.

nn_output_patch_size_minus1 plus 1 specifies the size of a neural network output patch in units of CtbSizeY. When not present, the value of nn_output_patch_size_minus1 is inferred to be equal to nn_input_patch_size_minus1.

Alternatively and similarly, the signalling of the output patch size precedes the signalling of the input patch, and the signalling of the input patch size may be omitted if the input patch size is equal to the output patch size.

In the embodiment described above, the sizes are commonly expressed in units of CtbSizeY. This is merely an example and other ways to express the sizes may be used, such as to express a size in units of a fixed number of luma sample such as in units of 16 luma samples. In another example, an index syntax element is used where each index value specifies a pre-defined size, for example two bits where the four possible index values specify the size values 64, 128, 256, and 512.

### 2. Min/Max Patch Size Information

In one embodiment, information specifying the maximum patch size for one or more input patches is signalled in the bitstream. In one example, the max patch size is M×N meaning that the patch size used by for example NNLF 404 can only be smaller than or equal to M×N. This means that for input patch sizes larger than M×N, NN loop filtering may not be applied.

In one embodiment, information specifying the minimum patch size for one or more input patches is signalled in the bitstream. In one example of this variant, for patch sizes smaller than the minimum patch size, an NN loop filter is not used, and only non-NN deblocking is calculated. In another example, NN loop filtering is not applied on the patch if the patch size in at least one dimension is smaller than the set minimum patch size. In one example patch sizes that have a width or height smaller than 16 pixels are deblocked using the non-neural network based deblocking filter and not NNLF 404.

In another embodiment, the min or max value of the patch size is applied to the number of the pixels in the patch. In one example, patch sizes that have fewer than 256 pixels are deblocked using the non-neural network based deblocking filter and not NNLF 404.

In various examples of this embodiment, information specifying the min and/or max patch sizes may be signalled in one or more of: per picture (e.g., in a slice header or picture header), per partial picture (e.g., in a slice header or for a tile or subpicture), in APS, in PPS, in SPS, in VPS

In another embodiment, the specified min or max value of the patch size is set relative to the CTU size or relative to another block size, such as the size of a CU.

Two examples of signalling the minimum and maximum patch size information in a parameter set, either as size syntax elements or width and height syntax elements, are described with the syntax and semantics below:

| | Descriptor |
|---|---|
| parameter_set_rbsp( ) { | |
| ... | |
| nn_min_patch_size_minus1 | ue(v) |
| nn_max_patch_size_minus1 | ue(v) |
| ... | |
| } | |

nn_min_patch_size_minus1[i] plus 1 specifies the minimum size of a neural network patch in units of CtbSizeY.

nn_max_patch_size_minus1[i] plus 1 specifies the maximum size of a neural network patch in units of CtbSizeY.

| | Descriptor |
|---|---|
| parameter_set_rbsp( ) { | |
| ... | |
| nn_min_patch_width_minus1 | ue(v) |
| nn_min_patch_height_minus1 | ue(v) |
| nn_max_patch_width_minus1 | ue(v) |
| nn_max_patch_height_minus1 | ue(v) |
| ... | |
| } | |

nn_min_patch_width_minus1[i] plus 1 specifies the minimum width of a neural network patch in units of CtbSizeY.

nn_min_patch_height_minus1[i] plus 1 specifies the minimum height of a neural network patch in units of CtbSizeY.

nn_max_patch_width_minus1[i] plus 1 specifies the maximum width of a neural network patch in units of CtbSizeY.

nn_max_patch_height_minus1[i] plus 1 specifies the maximum height of a neural network patch in units of CtbSizeY.

In one embodiment, the maximum size of the patch is obtained by a decoder, for example as a fixed maximum size, and the minimum size of the patch is derived from a syntax element decoded from a bitstream. The syntax element may here specify a delta value relative to the maximum size. In a second embodiment, the minimum size of the patch is obtained by a decoder, for example as a fixed minimum size, and the maximum size of the patch is derived from a syntax element decoded from the bitstream. The syntax element may here specify a delta value relative to the minimum size. In a third embodiment, the maximum and minimum sizes are both decoded from syntax elements in the bitstream. In combination with patch sizes derived based on splits as previously described and shown in FIG. 7, an obtained/derived maximum size may be used to define the sizes and positions of initial NN blocks. For an initial NN block, a split flag may be decoded that specifies whether the initial NN block is split or not. A split may here be done recursively. An NN block after a split may either be larger than the obtained/derived minimum size or not. If the NN block after the split is larger, a split flag for this NN block is decoded that specifies whether this NN block is further split or not. If the NN block after the split is not larger, no further split flag is decoded and the NN block is not further split.

3. Patch Size (Width and/or Height) as a Function of Picture Size

In one embodiment, NNLF 404 input may include patches with a size equal to the picture size. The size may be expressed as the width and/or the height value or as a single size value where the width and height are the same.

Using wide patches reduces the extra processing caused by the extra left and right border pixels in each input patch. If each input patch includes K extra sample values from the sides, using one patch for the width of the picture instead of N patches will reduce the number of processed sample columns by K*(N−1), see the example in FIG. 8.

In this variant, the patch size may be derived from the picture size instead of being explicitly signalled. In one version, the patch size is set equal to the picture size. In another version the patch size is set equal to a multiple of a block size (e.g., CTU size) that is the smallest size that is equal or larger than the picture size, e.g. patchWidthInSamples=CtbSizeY*Ceil (PicWidthInSamples/CtbSizeY), and patchHeightInSamples=CtbSizeY*Ceil (PicHeightInSamples/CtbSizeY).

In another version the patch size is set equal to a multiple of a block size (e.g., CTU size) that is the largest size that is equal or smaller than the picture size, e.g.

$$patchWidthInSamples = CtbSizeY * Floor ( PicWidthInSamples / CtbSizeY ) , and$$

$$patchHeightInSamples = CtbSizeY * Floor ( PicHeightInSamples / CtbSizeY ) .$$

4. Deriving Patch Size from the Picture Structure

In this embodiment, the patch size is derived from information pertaining to a structure part of the picture. The structure part of the picture may e.g., be a CTU, a slice, a subpicture or a tile.

In one example, the patch size is set to the size of the structure part of the picture. In another example, the patch size is set to a multiple of a block size (e.g., CTU size) that is the smallest size that is equal or larger than the size of the structure part of the picture. For example, the picture may have a subpicture structure and be divided into subpictures, where each subpicture comprises of 2×2 CTUs or 4×4 CTUs. The patch size is then set to 4×4 CTUs. In another example, the patch size is set to a multiple of a block size (e.g., CTU size) that is the largest size that is equal or smaller than the size of the structure part of the picture. In this example, the picture may also have a subpicture structure and be divided into subpictures, where each subpicture comprises of 2×2 CTUs or 4×4 CTUs. The patch size is in this case set to 2×2 CTUs.

In one example, a syntax element is signalled (i.e., included in the bitstream) that specifies that the patch size is to be derived from the size of a structure part of the picture. This is exemplified with the following syntax and semantics.

| | Descriptor |
|---|---|
| parameter_set_rbsp( ) { | |
| ... | |
| nn_patch_size_equal_to_ctu_size_flag | u(1) |
| ... | |
| nn_patch_size_equal_to_subpic_size_flag | u(1) |
| ... | |
| } | |

nn_patch_size_equal_to_ctu_size_flag equal to 1 specifies that the size of a neural network patch is equal to CtbSizeY. nn_patch_size_equal_to_ctu_size_flag equal to 0 specifies that the size of a neural network patch may not be equal to CtbSizeY.

nn_patch_size_equal_to_subpic_flag equal to 1 specifies that the size of a neural network patch is equal to the size of the current subpicture. nn_patch_size_equal_to_ctu_size_flag equal to 0 specifies that the size of a neural network patch may not be equal to the size of the current subpicture.

In another embodiment, a syntax element is signalled that specifies a number of patches, and the patch size is derived from the specified number of patches. The number of patches may be expressed in terms of the number of patches in vertical direction and the number of patches in horizontal direction.

The patch sizes may be derived from the picture size and the number of patches such that the patches are distributed uniformly over the picture. This is exemplified with the following syntax and semantics.

| | Descriptor |
|---|---|
| parameter_set_rbsp( ) { | |
| ... | |
| num_ver_nn_patches_minus1 | ue(v) |
| num_hor_nn_patches_minus1 | ue(v) |
| ... | |
| } | |

num_ver_nn_patches_minus1 plus 1 specifies the number of vertical neural network patches in a picture. num_ver_nn_patches_minus1 is also used to derive the heights of the neural network patches.

num_hor_nn_patches_minus1 plus 1 specifies the number of horizontal neural network patches in a picture. num_hor_nn_patches_minus1 is also used to derive the widths of the neural network patches.

The width of a neural network patch, in terms of samples, is derived as: Ceil (PicWidthInSamples/(num_hor_nn_patches_minus1+1)). And the height of a neural network patch, in terms of samples, is derived as: Ceil (PicHeightInSamples/(num_ver_nn_patches_minus1+1)).

Alternatively, the width of a neural network patch, in terms of the CTU size, is derived as: Ceil (PicWidthInCtbY/(num_hor_nn_patches_minus1+1)). And the height of a neural network patch, in terms of the CTU size, is derived as Ceil (PicHeightInCtbY/(num_ver_nn_patches_minus1+1)).

In one embodiment, for each row/column of patches, all patches have the same size, except the last neural network patch, for which the width/height has been cropped to fit the picture size.

In another embodiment, the patches of a row/column are distributed uniformly, but set such that the width/height of the smallest patch(es) are as large as possible while still fitting within the picture. For example, if the width of a picture is 10 CTUs and there are four patches, instead of dividing them horizontally into 3 CTUs, 3 CTUs, 3 CTUs, 1 CTU, they are for example divided into 3 CTUs, 3 CTUs, 2 CTUs, 2 CTUs.

5. Patch Information Derived from Profile, Tier or Level

In this embodiment, the patch information is derived from one or more of a profile indicator value, a tier indicator value, or a level indicator value. The one or more profile, tier or level indicator may be decoded from one or more syntax elements in the bitstream.

In one embodiment, a patch size is derived based on the one or more profile, tier or level indicator value. For example, if the indicator indicates that the bitstream conforms to a profile A, the patch size is determined to have a first size, e.g. 128×128. If the indicator indicates that the bitstream conforms to a profile B, the patch size is determined to have a second size, e.g. 256×256.

In another embodiment, the maximum patch size is restricted by the one or more profile, tier or level indicator value. For example, a level value of 2.1 may specify that the maximum patch size is 64×64 while a level value of 4.1 may specify that the maximum patch size is 256×256.

In another embodiment, whether to apply the NN is based on the profile, tier or level value. For instance, NNs are not applied for bitstreams conforming to a profile A, but may be applied for bitstreams conforming to a profile B. Another example would be that NNs are not applied for Main tier bitstreams, but may be applied to for High tier bitstreams. In yet another example, NNs are not applied for bitstreams conforming to a first level, e.g. level 2.1, but may be applied for bitstreams conforming to a second level, e.g. 4.1. In one version, the combination of the signalled patch size and the one or more profile, tier or level indicator values determines whether the NN may be applied or not, e.g. for a certain level the NN may only be applied on intra coded pictures or random access pictures (e.g. IDR and CRA pictures), but not for inter-coded pictures.

In another embodiment, the one or more profile, tier or level indicator determines the maximum number of patches allowed for a picture.

### 6. Signalling and Derivation of Margin Size

In this embodiment, which is based on any of the previous embodiments, the size of a margin of a patch is derived, for example, from a syntax element specifying the size.

In one embodiment, the size of the margin of the patch is derived based on the size of a central area of the patch. In one example, the size of the margin is a function of the size of the central area such that a larger central area is given a larger margin than a smaller central area.

For instance, if the size of the central area of the patch is 256×256 elements the size of the margin could be derived to be 8 elements on each side of the patch, and if the size of the central area of the patch is 1024×1024 elements the size of the margin could be derived to be 16 elements on each side of the patch. For very small central areas, e.g. with 16×16 elements, to avoid excessive processing overhead the margin could be omitted or be given a significantly smaller size, e.g. a margin size of 2 or 4 elements on each side of the central area.

In one embodiment, the margin size is restricted to be smaller than the size of central area of the input patch.

In one embodiment, the size of the margin is signalled or otherwise derived for each of the top margin, bottom margin, left margin and the right margin. For instance, the bitstream may include four syntax elements, where a first syntax element specifies the size of the top margin, a second syntax element specifies the size of the bottom margin, a third syntax element specifies the size of the right margin, and a fourth syntax element specifies the size of the left margin.

In one embodiment, the margin size is derived for the input patch. In one embodiment the signalled or derived margin size is for the output patch (the margin would then be the area to remove when cropping the output patch).

### 7. Patch Information Based on a Selected Filter

In this embodiment, from a set of two or more available NNLFs, an NNLF is selected to be applied, and the patch information (e.g., patch size) is derived based on the selected NNLF. In one example, the set of available NNLFs includes: a Very Low Operation Point (VLOP) NNLF, a Low Operation Point (LOP) NNLF, or a High Operation Point (HOP) NNLF, and the patch information comprises a first patch size or a second patch size or a third patch size based on the choice of the VLOP, LOP or HOP loop filters correspondingly. This is exemplified with the following syntax and semantics.

| | Descriptor |
|---|---|
| parameter_set_rbsp( ) { | |
| ... | |
| if(nnlf_VLOP) | |
| nnlf_VLOP_patch_size | ue(v) |
| elseif(nnlf_LOP) | |
| nnlf_LOP_patch_size | ue(v) |
| elseif(nnlf_HOP) | |
| nnlf_HOP_patch_size | ue(v) |
| ... | |
| } | |

nnlf_VLOP_patch_size specifies the input patch size of NN-based in-loop filter when VLOP model is used.

nnlf_LOP_patch_size specifies the input patch size of NN-based in-loop filter when LOP model is used.

nnlf_HOP_patch_size specifies the input patch size of NN-based in-loop filter when HOP model is used.

A decoder may perform all or a subset of the following steps to decode a picture:

### Step 1:

Obtain patch information for an NN filter where the NN filter may be an NN loop filter (e.g., NNLF 404). The patch information may be obtained by decoding it from the bitstream or it may be derived by other means, e.g., it may be transmitted out-of-band to the decoder or it may be inferred based on, for example, other information. The patch information may or may not explicitly specify a patch size, e.g., a size in terms of luma samples. The patch information may be signaled per picture (e.g., in a slice header or a picture header), for a part of a picture (e.g. slice, tile, subpicture), and/or in one or more parameter sets (e.g. APS, PPS, SPS or VPS).

The patch information may be inferred based on the picture size or a picture structure (e.g. CTU, CU, NN block or binary/quad splits of an NN-block).

The patch information may alternatively be obtained after selecting an NN filter from a set of available filters, and deriving the patch information based on the selected NN filter.

The obtained patch information may comprise: i) information specifying at least two or more different patch sizes for patches in a subpicture, a picture, a group of pictures or in a sequence; ii) information specifying a limitation (a.k.a., constraint) for a patch size (e.g. a max or min patch size); iii) information specifying an input patch size and/or an output patch size; iv) a flag indicating whether an input patch size is equal to an output patch size; v) information specifying a margin size; and/or vi) information from which a profile, tier or level indicator value can be derived.

### Step 2:

Decode the picture and/or other pictures using the obtained patch information. For example, in one embodiment, the patch information is used to generate at least one input patch that will be input into an NN filter, which uses the input patch to produce an output patch. The output patch may then be used to decode the picture and/or other pictures. For example, the output patch may be: blended with an output block from a deblocking filter (or other loop filter), filtered using another loop filter (e.g., SAO, ALF), or used as reference for other pictures.

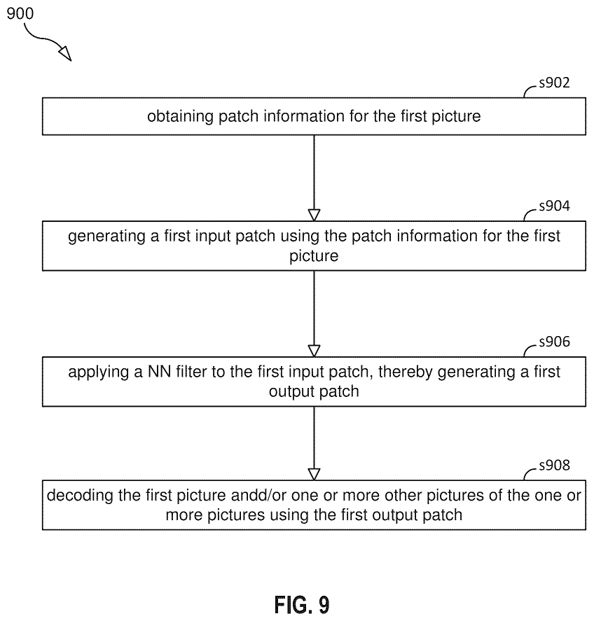

FIG. 9 is a flowchart illustrating a process 900 for decoding one or more pictures from a bitstream, the one or more pictures comprising a first picture. Process 900 may begin in step s902. Step s902 comprises obtaining patch information for the first picture. Step s904 comprises generating a first input patch using the patch information for the first picture. Step s906 comprises applying an NN filter to the first input patch, thereby generating a first output patch. Step s908 comprises decoding the first picture and/or one or more other pictures of the one or more pictures using the first output patch.

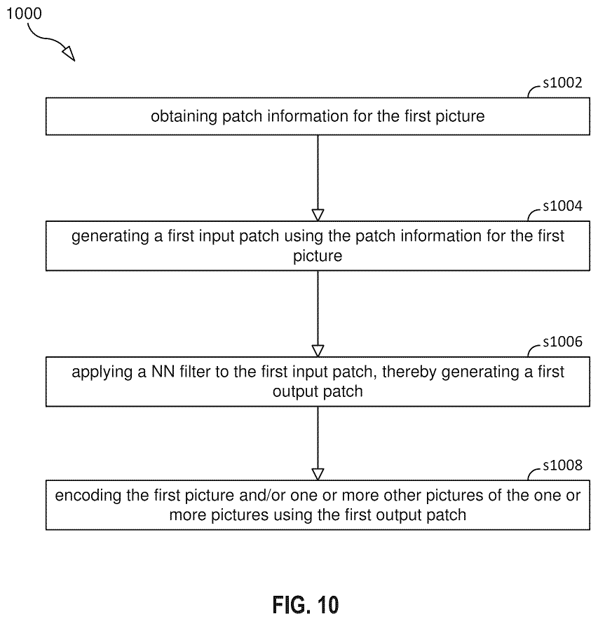

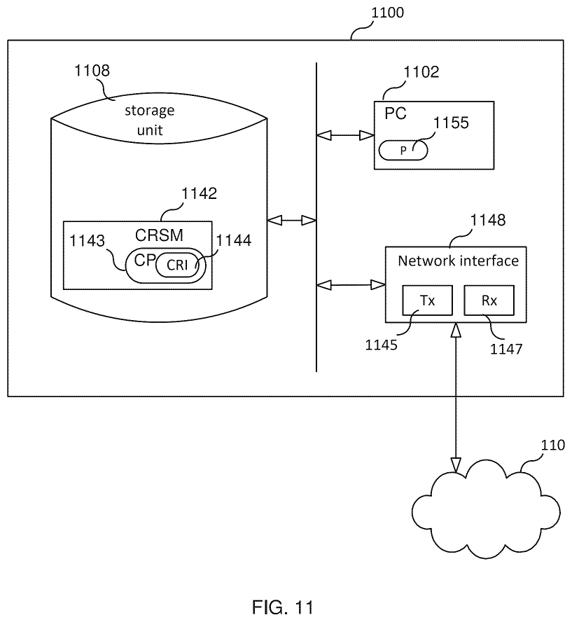

FIG. 10 is a flowchart illustrating a process 1000 for encoding one or more pictures in bitstream, the one or more pictures comprising a first picture. Process 1000 may begin in step s1002. Step s1002 comprises obtaining patch information for the first picture. Step s1004 comprises generating a first input patch using the patch information for the first picture. Step s1006 comprises applying an NN filter to the first input patch, thereby generating a first output patch. Step s1008 comprises encoding the first picture and/or one or more other pictures of the one or more pictures using the first output patch.

FIG. 11 is a block diagram of an apparatus 1100 for implementing encoder 102, device 103, and/or decoder 104, according to some embodiments. When apparatus 1100 implements encoder 102, apparatus 1100 may be referred to as an encoder apparatus, and when apparatus 1100 implements decoder 104, apparatus 1100 may be referred to as a decoder apparatus. As shown in FIG. 11, apparatus 1100 may comprise: processing circuitry (PC) 1102, which comprises one or more processors (P) 1155 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (e.g., apparatus 1100 may be a distributed, cloud computing system comprising two or more computers or a monolithic computing system consisting of a single computer); at least one network interface 1148 (e.g., a physical interface or air interface) comprising a transmitter (Tx) 1145 and a receiver (Rx) 1147 for enabling apparatus 1100 to transmit data to and receive data from other nodes connected to a network 110 (e.g., an Internet Protocol (IP) network) to which network interface 1148 is connected (physically or wirelessly) (e.g., network interface 1148 may be coupled to an antenna arrangement comprising one or more antennas for enabling encoder apparatus 1100 to wirelessly transmit/receive data); and a storage unit (a.k.a., “data storage system”) 1108, which may include one or more non-volatile storage devices and/or one or more volatile storage devices. In embodiments where PC 1102 includes a programmable processor, a computer readable storage medium (CRSM) 1142 may be provided. CRSM 1142 may store a computer program (CP) 1143 comprising computer readable instructions (CRI) 1144. CRSM 1142 may be a non-transitory computer readable medium, such as magnetic media (e.g., a hard disk), optical media, memory devices (e.g., random access memory, flash memory), and the like. In some embodiments, the CRI 1144 of computer program 1143 is configured such that when executed by PC 1102, the CRI causes encoder apparatus 1100 to perform steps described herein (e.g., steps described herein with reference to the flow charts). In other embodiments, encoder apparatus 1100 may be configured to perform steps described herein without the need for code. That is, for example, PC 1102 may consist merely of one or more ASICs. Hence, the features of the embodiments described herein may be implemented in hardware and/or software.

### Summary of Various Embodiments

A1. A method for decoding one or more pictures from a bitstream, the one or more pictures comprising a first picture, the method comprising: obtaining patch information for the first picture; generating a first input patch using the patch information for the first picture; applying a neural network, NN, filter to the first input patch, thereby generating a first output patch; and decoding the first picture and/or one or more other pictures of the one or more pictures using the first output patch.

B1. A method for encoding one or more pictures in bitstream, the one or more pictures comprising a first picture, the method comprising: obtaining patch information for the first picture; generating a first input patch using the patch information for the first picture; applying a neural network, NN, filter to the first input patch, thereby generating a first output patch; and encoding the first picture and/or one or more other pictures of the one or more pictures using the first output patch.

A2. The method of embodiment A1 or B1, wherein the patch information does not explicitly specify a size of the first input patch and/or the first output patch, the patch information is signalled as a size syntax element, or the patch information is signalled as width and/or height syntax elements.

A3. The method of any of the previous embodiments, wherein the patch information comprises information from which two or more different patch sizes can be derived for two or more patches in first picture, the patch information comprises information specifying a patch size limitation (a.k.a., “a patch size constraint,” such as a maximum or minimum patch size) for the first input patch and/or the first output patch, obtaining the patch information comprises deriving the patch information using information specifying a size of the first picture, obtaining the patch information comprises deriving the patch information using information regarding a structure (e.g. CTU) of the first picture, the patch information comprises information to obtain an input patch size and/or an output patch size, and/or obtaining the patch information comprises deriving the patch information using a profile indicator value, a tier indicator value, or a level indicator value.

A4. The method of any one of the previous embodiments, wherein the NN filter is an NN loop filter.

A5. The method of any one of the previous embodiments, wherein applying an NN filter to the first input patch comprises selecting an NN filter from a set of two or more available NN filters and applying the selected NN filter to the first input patch to produce the first output patch, and obtaining the patch information comprises deriving the patch information based on the selected NN filter.

A6. The method of any one of the previous embodiments, wherein the patch information is signaled in the bitstream and comprises information for deriving a patch size for the first input patch and/or the first output patch, and the information for deriving the patch size comprises: information specifying the size of a CTU, information specifying the size of a CU, information specifying the size of an NN block, information specifying splits (e.g. quad or binary splits) of an NN block, information specifying the size of the picture (e.g., width and/or height), information specifying the size of a part of the picture (e.g. tile, subpicture, or slice), and/or information specifying a number of patches (which may be signaled or derived).

A7. The method of any one of the previous embodiments, wherein the patch information comprises information specifying a patch size limitation (e.g. a max or min patch size) for the first input patch and/or the first output patch.

A8. The method of embodiment A7, wherein the information specifying a patch size limitation specifies a maximum and/or a minimum patch size.

A9. The method of embodiment A8, wherein applying the NN filter to the first input patch comprises applying the NN filter to the first input patch in response to: determining that the size of the first input patch is not greater than the maximum patch size, and/or determining that the size of the first input patch is not less than the minimum patch size.

A10. The method of any one of the previous embodiments, wherein patches are constrained to have the same patch size in at least one of: a subpicture, a picture, a group of pictures, or a sequence. That is, in one embodiment, patches in at least one of a subpicture, a picture, a group of pictures, or a sequence are constrained to have the same patch size.

A11. The method of any one embodiments A1-A9, wherein patches are not constrained to have the same patch size in at least one of: a subpicture, a picture, a group of pictures, or a sequence.

A12. The method of any one of the previous embodiments, wherein the patch information is signalled per picture (e.g., in a slice header or a picture header), for a part of a picture (e.g. slice, tile, subpicture), and/or in one or more parameter sets (e.g. APS, PPS, SPS or VPS).

A13. The method of any one of the previous embodiments, wherein the patch information comprises a patch size and the patch size is signalled as a size syntax element or width and/or height syntax elements.

A14. The method of any one of the previous embodiments, wherein the bitstream is a video bitstream comprising coded pictures.

A15. The method of any one of the previous embodiments, wherein the patch information is for one of the first input patch or the first output patch, or the patch information is for both the first input patch and the first output patch.

A16. The method of any one of the previous embodiments, wherein the patch information comprises information specifying a patch size limitation (e.g. a max or min patch size) for the first input patch and/or the first output patch, and the patch size limitation is based on a profile indicator value, a tier indicator value, or level indicator value.

A17. The method of embodiment A16, wherein the profile indicator value, the tier indicator value, or the level indicator value is used to determine whether to apply the NN filtering.

A18. The method of any one of the previous embodiments, wherein the patch information comprises: information specifying a position for the first input patch and/or the first output patch, information specifying a size for the first input patch and/or the first output patch, information specifying a size of a margin for the first input patch and/or the first output patch, information specifying a width of a margin for the first input patch and/or the first output patch, and/or information specifying a height of a margin for the first input patch and/or the first output patch.

A19. The method of embodiment A18, wherein the size, width, and/or height of the margin is derived from the size, width, and/or height of a patch.

A20. The method of embodiment A18, wherein the output patch size is derived from the input patch size or the input patch size is derived from the output patch size.

A21. The method of any one of embodiments A16-A18, wherein the method further comprises: decoding from the bitstream a flag indicating whether the first output patch size is equal to the first input patch size, or including in the bitstream a flag indicating whether the first output patch size is equal to the first input patch size.

A21.5. The method of any one of embodiments B1 or A2-A21, wherein the method further comprises: including in the bitstream a flag indicating whether the first output patch size is equal to the first input patch size.

A22. The method of any one of embodiments A1 or A2-A21, wherein obtaining the patch information comprises: decoding the patch information from the bitstream, and/or deriving the patch information from one or more syntax elements or by using external means.

A23. The method of any one of embodiments B1 or A2-A21, wherein the method further comprises: including the patch information in the bitstream, or including in the bitstream one or more syntax elements from which the patch information can be derived.

C1. A computer program (1143) comprising instructions (1144) which when executed by processing circuitry (1102) of an apparatus (1100) causes the apparatus to perform the method of any one of the above embodiments.

C2. A carrier containing the computer program of embodiment C1, wherein the carrier is one of an electronic signal, an optical signal, a radio signal, and a computer readable storage medium (1142).

D1. A decoding apparatus (1100) for decoding a picture from a bitstream, the decoding apparatus being configured to: obtain patch information for the first picture; generate a first input patch using the patch information for the first picture; apply a neural network, NN, filter to the first input patch, thereby generating a first output patch; and decode the first picture and/or one or more other pictures of the one or more pictures using the first output patch.

D2. The decoding apparatus of embodiment D1, wherein the decoding apparatus is further configured to perform the method of any one of embodiments A2-A22.

E1. An encoding apparatus (1100), the encoding apparatus being configured to: obtain patch information for a first picture of one or more pictures; generate a first input patch using the patch information for the first picture; apply a neural network, NN, filter to the first input patch, thereby generating a first output patch; and encode the first picture and/or one or more other pictures of the one or more pictures using the first output patch.

E2. The encoding apparatus of embodiment E1, wherein the encoding apparatus is further configured to perform the method of any one of embodiments A2-A21 or A23.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for decoding one or more pictures from a bitstream, the one or more pictures comprising a first picture, the method comprising:
obtaining patch information for the first picture;
generating a first input patch using the patch information for the first picture;
applying a neural network (NN) filter to the first input patch, thereby generating a first output patch; and
decoding the first picture and/or one or more other pictures of the one or more pictures using the first output patch.

2. The method of claim 1, wherein
the patch information does not explicitly specify a size of the first input patch and/or the first output patch,
the patch information is signalled as a size syntax element, or
the patch information is signalled as width and/or height syntax elements.

3. The method of claim 1, wherein
the patch information comprises information from which two or more different patch sizes can be derived for two or more patches in the first picture,
the patch information comprises information specifying a patch size constraint for the first input patch and/or the first output patch,
obtaining the patch information comprises deriving the patch information using information specifying a size of the first picture,
obtaining the patch information comprises deriving the patch information using information regarding a structure of the first picture,
the patch information comprises information to obtain an input patch size and/or an output patch size, and/or
obtaining the patch information comprises deriving the patch information using a profile indicator value, a tier indicator value, or a level indicator value.

4. The method of claim 3, wherein the information specifying a patch size constraint specifies a maximum patch size and/or a minimum patch size.

5. The method of claim 4, wherein applying the NN filter to the first input patch comprises applying the NN filter to the first input patch in response to:
determining that the size of the first input patch is not greater than the maximum patch size, and/or
determining that the size of the first input patch is not less than the minimum patch size.

6. The method of claim 1, wherein
the patch information is signaled in the bitstream and comprises information for deriving a patch size for the first input patch and/or the first output patch, and
the information for deriving the patch size comprises:
information specifying the size of a CTU,
information specifying the size of a CU,
information specifying the size of an NN block,
information specifying splits of an NN block,
information specifying the size of the picture,
information specifying the size of a part of the picture, and/or
information specifying a number of patches.

7. The method of claim 1, wherein the NN filter is an NN loop filter.

8. The method of claim 1, wherein
applying an NN filter to the first input patch comprises selecting an NN filter from a set of two or more available NN filters and applying the selected NN filter to the first input patch to produce the first output patch, and
obtaining the patch information comprises deriving the patch information based on the selected NN filter.

9. The method of claim 1, wherein the patch information is signalled per picture, for a part of a picture, and/or in one or more parameter sets.

10. The method of claim 1, wherein patches in at least one of a subpicture, a picture, a group of pictures, or a sequence are constrained to have the same patch size.

11. The method of claim 1, wherein the patch information comprises a patch size and the patch size is signalled as a size syntax element or width and/or height syntax elements.

12. The method of claim 1, wherein
the patch information is for one of the first input patch or the first output patch, or
the patch information is for both the first input patch and the first output patch.

13. The method of claim 1, wherein
the patch information comprises information specifying a patch size constraint for the first input patch and/or the first output patch, and
the patch size constraint is based on a profile indicator value, a tier indicator value, or level indicator value.

14. The method of claim 13, wherein the profile indicator value, the tier indicator value, or the level indicator value is used to determine whether to apply the NN filtering.

15. The method of claim 1, wherein the method further comprises:
decoding from the bitstream a flag indicating whether the first output patch size is equal to the first input patch size.

16. The method of claim 1, wherein the patch information comprises:
information specifying a position for the first input patch and/or the first output patch,
information specifying a size for the first input patch and/or the first output patch,
information specifying a size of a margin for the first input patch and/or the first output patch,
information specifying a width of a margin for the first input patch and/or the first output patch, and/or
information specifying a height of a margin for the first input patch and/or the first output patch.

17. The method of claim 16, wherein
the size, width, and/or height of the margin is derived from the size, width, and/or height of a patch, and/or
the output patch size is derived from the input patch size or the input patch size is derived from the output patch size.

18. The method of claim 1, wherein obtaining the patch information comprises:
decoding the patch information from the bitstream, and/or
deriving the patch information from one or more syntax elements or by using external means.

19. A decoding apparatus, the decoding apparatus comprising:
memory; and
processing circuitry, wherein the encoding apparatus is configured to perform a method for decoding one or more pictures from a bitstream, the one or more pictures comprising a first picture, the method comprising:
obtaining patch information for the first picture;
generating a first input patch using the patch information for the first picture;
applying a neural network (NN) filter to the first input patch, thereby generating a first output patch; and
decoding the first picture and/or one or more other pictures of the one or more pictures using the first output patch.

20. A method for encoding one or more pictures in bitstream, the one or more pictures comprising a first picture, the method comprising:
obtaining patch information for the first picture;
generating a first input patch using the patch information for the first picture;
applying a neural network (NN) filter to the first input patch, thereby generating a first output patch; and
encoding the first picture and/or one or more other pictures of the one or more pictures using the first output patch.

21. An encoding apparatus, the encoding apparatus comprising:
memory; and
processing circuitry, wherein the encoding apparatus is configured to perform a method for encoding one or more pictures in bitstream, the one or more pictures comprising a first picture, the method comprising:
obtaining patch information for the first picture;
generating a first input patch using the patch information for the first picture;
applying a neural network (NN) filter to the first input patch, thereby generating a first output patch; and
encoding the first picture and/or one or more other pictures of the one or more pictures using the first output patch.
